(19) United States
(12) Patent Application Publication
(10) Pub. No.: US 2007/0180776 A1
(43) Pub. Date: Aug. 9, 2007

(54) Weather strip

(75) Inventors: Kisato Oba, Aichi-ken (JP); Masahiro Nozaki, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Aichi-ken (JP)

(21) Appl. No.: 11/493,918

(22) Filed: Jul. 27, 2006

(30) Foreign Application Priority Data
Jul. 28, 2005 (JP) P-2005-218581
Nov. 30, 2005 (JP) P-2005-346478

(51) Int. Cl. E06B 7/22

(52) U.S. Cl. 49/498.1

(57) ABSTRACT

There is provided an automotive weather strip for sealing a gap between an open/close member of a vehicle body opening and a peripheral part of the vehicle body opening, having a trim portion mounted on a flange and a hollow seal portion provided integrally on the trim portion. The trim portion is provided with at least a bottom wall and an exterior side wall. A pressure sensitive adhesive double sided tape is adhered to an interior side surface of the exterior side wall to thereby be bonded to the flange. A caulking sponge is mounted on an inner surface of the bottom wall so as to seal a distal end of the flange. The caulking sponge is formed such that an interior end portion thereof protrudes from the bottom wall more largely than any other portions thereof.

### BACKGROUND OF THE INVENTION

1. Field of the Invention

The present invention relates to a weather strip in an automobile for sealing a gap between an open/close member for a vehicle body opening such as a door, a trunk lid and a sliding roof of a motor vehicle which opens and closes a vehicle body opening and a peripheral part of the vehicle body opening.

2. Related Art

Conventionally, as shown in FIG. 12, the sealing of a gap between an automotive door 2 and a vehicle body opening peripheral part 6 is effected by a door weather strip 160 which is mounted in a retainer 4 along an outer periphery of a door frame or the like of the door 2, a glass run 150 which is mounted within a channel 3 along an inner periphery of the door frame or the like and an opening trim weather strip 110 which is mounted on a flange 7 along the vehicle body opening peripheral part 6.

Note that the flange 7 is formed by joining together panels such as an outer panel 6a which defines the vehicle body opening peripheral part 6, an inner panel 8 which lies to the interior of a passenger compartment and the like.

The glass run 150 movably receives end portions of a door glass 5 in the door 2 in an interior of a main body thereof which is provided with an exterior side wall 151, a bottom wall 152 and an interior side wall 153 so as to form a substantially U-shaped cross section, and holds and seals the end portions of the door glass 153 with an exterior seal lip 154 and an interior seal lip 155 which are provided so as to extend from distal ends of the exterior side wall 151 and the interior side wall 153, respectively.

The door weather strip 160 mounted on an outer periphery of the door 2 is provided with a mounting base portion 161, a hollow seal portion 164 which is formed integrally on an upper portion of the mounting base portion 161 and a seal lip portion 166. The mounting base portion 161 is fitted in the retainer 4 provided along the outer periphery of the door frame so as to be fixed to the door frame. In addition, when the door 2 is closed, the seal lip portion 166 is brought into contact with a most exterior edge of the vehicle body opening peripheral part (the outer panel 6a) 6 so as to seal a gap between the door 2 and an exterior edge of the vehicle body opening peripheral part 6. As this occurs, the hollow seal portion 164 is brought into contact with a projecting portion of the vehicle body opening peripheral part 6 which lies closer to the inside of the passenger compartment than the portion of the peripheral part 6 with which the seal lip portion 166 is brought into contact so as to seal the gap between the door 2 and the vehicle body opening peripheral part 6.

The opening trim weather strip 110, which is mounted on the flange 7, resides along the vehicle body opening peripheral part 6 so as to seal the gap between the door 2 and the vehicle body opening peripheral part 6 at a portion which lies closer to the inside of the passenger compartment than the portion where the door weather strip 160 seals the vehicle body opening peripheral part 6. The opening trim weather strip 110 is mounted on the flange 7 by a trim portion 120 which functions as a mounting base portion having a substantially U-shaped cross section, so that a hollow seal portion 130 thereof is brought into contact with a projecting portion 2a of the door frame. A core material 124 such as a metallic insert is embedded in the trim portion 120 so as to grip on the flange 7, and flange holding lips are provided in an interior of the substantially U-shaped cross section of the trim portion 120.

However, the flange is formed by joining together an end portion of the outer panel 6a which defines the vehicle body opening peripheral part 6 and an end portion of the panel such as the inner panel 8 or the like by welding or the like, and the outer panel 6a and the inner panel 8a form a cavity in the vicinity of the flange 7. Noises such as wind noise, tire noise, noise reflected from the road surface and the like are transmitted along the full periphery of the vehicle body opening peripheral part 6 through this cavity. There may occur a case where gaps are generated between the flange and the interior of the trim portion 120 due to irregularities resulting from spot welding and irregularities due to sheet metal working carried out on an end portion of the flange 7, and the aforesaid noises are leaked from the gaps to thereby be transmitted to the inside of the passenger compartment.

Due to this, there exists a technique in which as shown in FIG. 13, in order to enhance the sealing properties of an opening trim weather strip 110 at the distal end of the flange 7, a reverse V-shaped lip 129 is formed on an inner surface of a bottom wall 123 of a trim portion 120 thereof so as to protrude into the interior of the trim portion 120, so that the distal end of the flange 7 is brought into contact with this reverse V-shaped lip 129 (for example, refer to JP-UM-A-55-9716).

In this case, only the reverse V-shaped lip 129 formed within the trim portion 120 is in contact with the distal end of the flange 7, and in the event that the distal end of the flange 7 deviates slightly, the distal end of the flange 7 moves apart from the reverse V-shaped lip 129, and hence, sufficient sealing properties could not be obtained.

In addition, there exists a technique in which as shown in FIG. 14, in order to enhance the sealing properties of an opening trim weather strip 110 at the distal end of the flange 7, a plurality of seal members 126 which are formed of a soft material such as a sponge material or the like are formed on an inner surface of a bottom wall 123 in the interior of a trim portion 120 thereof so as to encapsulate the distal end of the flange 7 by the plurality of seal members 126 (for example, refer to JP-UM-A-55-65209).

In this case, while the flexibility of the seal member 126 is larger than that of the one shown in FIG. 13, the distal end of the flange 7 needs to be positioned properly at the center of the seal members 126, and in addition, in the event that the thickness of the flange 7 varies, the seal members 126 cannot correspond to the variation in thickness so properly as to encapsulate the distal end of the flange 7 entirely, and hence, sufficient sealing properties could not be obtained.

Furthermore, there exists a technique in which as shown in FIG. 15, in order to enhance the sealing properties of an opening trim weather strip 110 at the distal end of the flange 7, a seal member having viscosity or a seal member 126 which is formed of a soft material such as a sponge material is mounted in the interior of a trim portion 120, so that the distal end of the flange 7 is inserted into the inside of the seal member 126 (for example, refer to JP-UM-A-54-31622).

In this case, labor hours are necessary to insert the seal member 126 which is formed separately into the interior of the trim portion 120 having the substantially U-shaped cross section. In addition, with the seal member 126 having viscosity used, when the trim portion 120 is removed from the flange 7 for repair, there may occur a case where the seal member 126 adheres to the flange 7 and the trim portion 120 to thereby damage the appearance of the vehicle. When the seal member 126 formed from the soft material such as the sponge material, similar to that shown in FIG. 14, with the thickness of the flange 7 varying, the seal member 126 cannot encapsulate the distal end of the flange 7 by varying according to the variation in the thickness of the flange 7, and hence, sufficient sealing properties could not be obtained.

In addition, in many cases, the opening trim weather strip 110 is mounted along the full periphery of the vehicle body opening peripheral part 6 which defines the opening in the vehicle body where the door 2 is placed to open and close the opening, and the flange 7 of the vehicle body opening peripheral part 6 varies in thickness depending on its locations. Namely, while the flange 7 is formed by joining together the distal ends of the panels which constitute the vehicle body, the number of panels which are joined together varies from one to on the order of five depending on the locations thereon, and the thickness thereof varies in a range approximately from 2 mm to 8 mm.

Due to this, in the event that the trim portion 120 is formed to have a substantially U-shaped cross section with a metallic reinforcement insert as a core material 124 embedded therein to hold the flange 7 in the U-shaped cross section, there was a case where the inserting force varied largely or the gripping force applied on the flange 7 decreased.

In addition, the weight of the trim portion 120 is increased by virtue of the embedding of the metallic insert, and hence, the demand for a light-weight vehicle was not satisfied.

Due to this, there is proposed a technique in which the core material 124 such as the metallic insert is made unnecessary in a trim portion 120 so as to increase the flexibility of the trim portion 120, and then, the trim portion 120 is attached to the flange 7 using a pressure sensitive adhesive double sided tape 125 (for example, refer to JP-A-2001-151035).

In this case, in the trim portion 120 (the mounting base portion) 120 of an opening weather strip 110, the pressure sensitive adhesive double sided tape 125 is attached to an inner surface of an exterior side wall 122, and then, the flange 7 is inserted into the interior of the trim portion 120, while the pressure sensitive adhesive double sided tape 125 can be secured to an exterior side surface of the flange 7 under pressure.

In the event that the thickness of the flange 7 varies largely, there is adopted a technique in which a trim portion (a mounting base portion) 120 is formed to have a substantially L-shaped cross section, not the substantially U-shaped cross section, to thereby omit the interior side wall so as to allow the flange 7 to freely project toward the inside of the passenger compartment.

In the event that the trim portion 120 is formed to have the substantially L-shaped cross section with the metallic insert deleted, however, the rigidity of the trim portion 120 is reduced, and hence, there was a risk that a bottom wall 123 deforms slightly, whereby the distal end of the flange 7 moves apart from a seal member 126 to thereby reduce the sealing properties. In particular, in the event that the interior side end of the flange 7 moves apart from the seal member 126, noises enter the interior of the passenger compartment from the distal end of the flange 7. Due to this, there exists a technique in which in the event that the trim portion 120 is formed to have the substantially L-shaped cross section, the seal member 126 is formed so as to be thicker as it extends toward a distal end of the bottom wall 123. However, the sealing properties provided were not sufficient.

Furthermore, when the flange 7 is provided with a plurality of panels, the dimensions of distal ends thereof vary, and when the bottom wall 123 deforms, there occurred a case where the distal ends of the panels deviate from the seal member 126 of the bottom wall 123.

In addition, when the opening trim weather strip 110 is bonded to the flange 7 by the pressure sensitive adhesive double sided tape 125, a protection tape on the pressure sensitive adhesive double sided tape 125 is peeled off, the flange 7 is inserted into the interior of the trim portion 120, and the pressure sensitive adhesive double sided tape 125 is secured to the side of the flange 7 under pressure. As this occurs, sometimes there occurred a case where the distal end of the flange 7 came into contact with the pressure sensitive adhesive double sided tape 125 to thereby peel off the same tape or the flange 7 was not inserted deep enough into the trim portion 120 to end up with being bonded to the pressure sensitive adhesive double sided tape on its way to the proper place in the trim portion 120.

### SUMMARY OF THE INVENTION

In view of the above circumstances, an object of the invention is to provide a weather strip for a vehicle which can easily be mounted and ensure the prevention of intrusion of noise from the flange. Further, another object of the invention is to provide a weather strip which can prevent the intrusion of noises from a flange assuredly even in case the dimension of the distal end of the flange varies.

According to a first aspect of the invention, there is provided an automotive weather strip for sealing a gap between an open/close member of a vehicle body opening and a peripheral part of the vehicle body opening, the weather strip having:

a mounting base portion adapted to be mounted on a flange provided on one of the open/close member and the vehicle body opening peripheral part and a seal portion provided integrally on the mounting base portion so as to be brought into contact with the other of the open/close member and the vehicle body opening peripheral part so as to seal the gap between the open/close member and the vehicle body opening peripheral part, wherein

the mounting base portion is provided with at least a bottom wall and an exterior side wall, and wherein

a pressure sensitive adhesive double sided tape is adhered to an interior side surface of the exterior side wall, and a caulking member is mounted on an inner surface of the bottom wall, the caulking member being formed such that an interior end portion of the caulking member protrudes from the bottom wall more largely than any other portions thereof.

In the first aspect of the invention, the weather strip has the mounting base portion adapted to be mounted on the flange provided on one of the open/close member and the vehicle body opening peripheral part and the seal portion provided integrally on the mounting base portion so as to be brought into contact with the other of the open/close member and the vehicle body opening peripheral part so as to seal the gap between the open/close member and the vehicle body opening peripheral part. Due to this, when the open/close member is closed, the seal portion is brought into contact with the vehicle body opening peripheral part or the open/close member, so that the gap between the open/close member and the vehicle body opening peripheral part can be sealed.

Since the mounting base portion is provided with at least the bottom wall and the exterior side wall, even in the event that the thickness of the flange varies, the distal end of the flange can be held to be sealed by the bottom wall assuredly with a side of the flange brought into tight contact with the exterior side wall. By bringing the distal end of the flange into contact with the bottom wall, the exterior side wall can be positioned in a predetermined position.

In addition, since the pressure sensitive adhesive double sided tape is adhered to the interior side surface of the exterior side wall, the mounting base portion can be mounted on the flange irrespective of the thickness of the flange, and an area where the pressure sensitive adhesive double sided tape is adhered is increased, so that the mounting base portion can be bonded strongly and rigidly.

Since the caulking member is mounted on the inner surface of the bottom wall, the caulking member being formed such that the interior end portion of the caulking member protrudes from the bottom wall more largely (higher) than any other portions thereof, even in the event that after installation, the bottom wall of the trim portion rotates about its connecting portion with the exterior side wall to thereby deform in a direction in which the bottom wall moves apart from the distal end of the flange after it has been brought into contact with the distal end of the flange, since the caulking member is formed to exceed in height than the deformation dimension of the bottom wall, the bottom wall is allowed to remain in contact with the distal end of the flange, thereby making it possible to secure the sealing properties.

In addition, since the caulking member is formed so as to protrude from the bottom wall to a largest extent (highest) at an interior edge thereof, the end portion of the flange and the caulking member are brought into tight contact with each other, thereby eliminating the risk of noises or the like infiltrating the interior of the passenger compartment.

According to the invention, the bottom wall may be formed of a hard material.

In this aspect of the invention, the rigidity is increased, and the bottom wall deforms little after the mounting base portion is brought into contact with the distal end of the flange, and the distal end of the flange can continue to abut the caulking member, thereby making it possible to secure the sealing properties between the distal end of the flange and the caulking member of the bottom wall. In addition, the hard material deforms little and hence, stretches little relative to the flange when the weather strip is mounted on the flange, whereby there occurs no case where part of the weather strip is caused to float from the flange or the weather strip is creased.

According to the invention, an insert member may be embedded within the exterior side wall and the bottom wall.

In this aspect of the invention, rigidities of the exterior side wall and the bottom wall are increased, and hence, after the weather strip is mounted on the flange, the exterior side wall and the bottom wall deform little. Consequently, there occurs no case where the bottom wall rotates about the connecting portion with the exterior side wall to deflect, thereby making it possible to secure the sealing properties between the distal end of the flange and the bottom wall. The bottom wall and the exterior side wall can be formed of the same material, this facilitating the extrusion. In addition, the insert member deforms little and hence stretches little when the weather strip is mounted on the flange, whereby there occurs no case where part of the weather strip is caused to float from the flange or the weather strip is creased.

According to the invention, the caulking member may be formed so as to increase gradually its protruding amount in a slope-like manner from an exterior end portion to an interior end portion of the bottom wall.

In this aspect of the invention, even in the event that the bottom wall rotates about the connecting portion with the exterior side wall to deflect, due to the caulking member being formed such that the protruding amount increases according to the deformation dimension of the bottom wall, the caulking member mounted on the bottom wall and the distal end of the flange can be brought into tight contact with each other, so as to secure the sealing properties.

According to the invention, the caulking member may be formed so as to increase sequentially its protruding amount in a stepped manner from an exterior end portion to an interior end portion of the bottom wall.

In this aspect of the invention, even in the event that the bottom wall rotates about the connecting portion with the exterior side wall to deflect, the distal end of the flange can be encapsulated by the caulking member, whereby the caulking member mounted on the bottom wall and the distal end of the flange can be brought into tight contact with each other, so as to secure the sealing properties.

According to the invention, the caulking member may have an empty space between the bottom wall and the caulking member or in the caulking member along an interior end portion of the bottom wall.

In this aspect of the invention, the flexibility of an interior end portion of the caulking member is increased, so that the distal end of an interior end portion of the flange can be inserted deeper into the interior of the caulking member, whereby even in the event that the bottom wall deforms more largely, the caulking member and the distal end of the flange can be brought into tight contact with each other, so as to secure the sealing properties.

According to the invention, the caulking portion may have a first lip-like portion which is provided at a position along an interior end portion of the bottom wall so as to extend substantially in parallel to the exterior side wall forming a wall toward an inner surface side of the bottom wall and a second lip-like portion which is provided so as to extend obliquely from a distal end of the first lip-like portion toward a connecting portion between the bottom wall and the exterior side wall.

In this aspect of the invention, when the distal end of the flange is brought into contact with the first lip-shaped portion of the caulking member, the distal end of the interior end portion is pulled by the lip portion, and the distal end of the interior end portion bends onto an interior side of the flange so as to encapsulate and seal the side end of the flange.

The portion where a second lip-like portion is provided so as to extend obliquely from the distal end of the first lip-like portion toward the connecting portion between the bottom wall and the exterior side wall has an empty space having a substantially triangular cross section which is defined between the bottom wall, the lip portions and the interior end portion, and when the distal end of the flange is brought into contact with the second lip-like portion, the caulking member can deform more as it extends further inward of the flange, and even though the bottom wall deforms, the sealing properties can be secured.

According to the invention, a stepped portion with which a distal end of the flange is locked may be formed in the vicinity of a connecting portion between the inner surface of the bottom wall and the exterior side wall.

In this aspect of the invention, a position can be determined assuredly where the weather strip is mounted on the flange. In addition, since the distal end of an outer panel of the flange is positioned by the stepped portion on the bottom wall, the mounting position of the mounting member of the weather strip on the flange can be determined based on the distal end of the outer panel, and therefore, there occurs no case where the mounting position varies.

According to the invention, the mounting base portion may be provided with the exterior side wall, an interior side wall and the bottom wall so as to have a substantially U-shaped cross section, and an interior holding lip may be provided so as to extend obliquely from a distal end of the interior side wall in a direction of an interior of the substantially U-shaped cross section, so that the interior holding lip is brought into contact with a side of the flange.

In this aspect of the invention, the flange can be held by the exterior side wall and the interior side wall therebetween, so as to hold the distal end of the flange by the bottom wall. In addition, by bringing the distal end of the flange into contact with the bottom wall, the exterior side wall can be mounted at a predetermined position.

Since the interior holding lip is provided so as to extend obliquely from the distal end of the interior side wall in the direction of the interior of the substantially U-shaped cross section, so that the interior holding lip is brought into contact with the side of the flange, the interior holding lip cannot only seal the interior side of the flange but also holds the flange in cooperation with the exterior side wall. Furthermore, even in case the thickness of the flange varies, the interior holding lip can deflect as the thickness of the flange varies, thereby making it possible to maintain the sealing properties.

According to the invention, the open/close member may be a door and the weather strip may be an opening trim weather strip.

In this aspect of the invention, not only a gap between the vehicle body opening peripheral part and the door can be sealed assuredly but also noises attempting to intrude into the interior of the passenger compartment from the gaps in the flange can be encapsulated by the mounting base portion to thereby ensure the prevention of such noise intrusion.

According to the invention, the seal portion and the caulking member of the weather strip may be formed of an EPDM rubber or a sponge material of an olefin-based thermoplastic elastomer, and the mounting base portion may be formed of an EPDM rubber, or a solid material or finely foamed material of an olefin-based thermoplastic elastomer.

In this aspect of the invention, a simultaneous extrusion can be effected using the same kind of material, so as to obtain a product having good weathering properties. In addition, since the product so extruded is formed of the same olefin-based resin or rubber, it can be recycled for reuse without separating the material, thus making it possible to obtain the product that can easily be recycled.

In the invention, since the pressure sensitive adhesive double sided tape is adhered to the interior side surface of the exterior side wall, the mounting base portion can be mounted on the flange irrespective of the thickness of the flange, and the area where the pressure sensitive adhesive double sided tape is adhered can be increased, so that the mounting base portion can be bonded strongly and rigidly.

Since the caulking member is formed such that the interior end portion of the caulking member protrudes from the bottom wall more largely than any other portions thereof, even in the event that after having been mounted on the flange, the bottom wall of the trim portion rotates about the connecting portion with the exterior side wall to thereby deform, due to the caulking member being formed to protrude from the bottom wall more largely than any other portions thereof, the bottom wall is allowed to remain in contact with the distal end of the flange, thereby making it possible to secure the sealing properties.

Further, since the hollow noise insulating portion is formed of the soft member to have the substantially triangular cross section in which the side thereof with which the flange is brought into contact is formed into the slope which is higher along the distal side and is lower along the proximal side of the bottom wall, the hollow noise insulating portion can encapsulate the distal end of the flange flexibly, so that not only the noise insulating properties can be enhanced but also the sealing properties can be secured.

According to the invention, the bottom wall may be formed of a hard member, and a hollow noise insulating portion may be formed on an inner surface of the bottom wall, the hollow noise insulating portion being formed of a soft member to have a substantially triangular cross section with a side thereof with which the flange is brought into contact formed into a slope which is higher along a distal side and is lower along a proximal side of the bottom wall.

In this aspect of the invention, even in the event that thickness of the flange varies, a distal end of the flange can be held and sealed assuredly by the bottom wall while a side of the flange is brought into tight contact with the exterior side wall. By bringing the distal end of the flange into contact with the bottom wall, the exterior side wall can be positioned in a predetermined position.

In addition, since the pressure sensitive adhesive double sided tape is adhered to the interior side surface of the exterior side wall, the mounting base portion can be mounted on the flange irrespective of the thickness of the flange, and an area where the pressure sensitive adhesive double sided tape is increased, so that the mounting base portion can be bonded strongly and rigidly.

Since the bottom wall is formed of the hard member and the hollow noise insulating portion is formed on the inner surface of the bottom wall, the rigidity of the bottom wall is increased, and even in the event that the distal end of the flange is brought into contact with the bottom wall, there occurs no case where the bottom wall deforms largely. Due to this, when the weather strip is mounted on the flange, the bottom wall can come into contact with the distal end of the flange, so as to seal a gap between the flange and the bottom wall.

The hollow noise insulating portion is formed of the soft member to have the substantially triangular cross section in which the side thereof with which the flange is brought into contact is formed into the slope which is higher along the distal side and is lower along the proximal side of the bottom wall. Therefore, the hollow noise insulating portion can encapsulate the distal end of the flange flexibly, so that the noise insulating properties are enhanced. In addition, even in the event that after installation, the bottom wall of the mounting base portion rotates about its connecting portion with the exterior side wall to thereby deform in a direction in which the bottom wall moves apart from the distal end of the flange after it has been brought into contact with the distal end of the flange, since the hollow noise insulating portion is formed to exceed in height than the deformation dimension of the bottom wall, the bottom wall is allowed to remain in contact with the distal end of the flange, thereby making it possible to secure the sealing properties.

Furthermore, since the hollow noise insulating portion is formed into the hollow shape, even in the event that distal ends of a plurality of panels which constitute the flange vary, the deformable capacity of the hollow noise insulating portion is large, and hence, the distal ends of the panels are separated in no case.

In addition, since the hollow noise insulating portion is formed highest at an interior edge thereof, an end portion of the flange and the hollow noise insulating portion are brought into tight contact with each other, and hence, noises or the like are allowed in no case to intrude into the interior of a passenger compartment. Additionally, since the hollow noise insulating portion is flexible, even in the event that the mounting base portion is mounted in a corner portion of the vehicle body opening peripheral part, the mounting base portion can deform so as to follow the corner portion so as to be mounted properly.

According to the invention, the hollow noise insulating portion may be connected to the bottom wall at a noise insulating portion proximal connecting portion located on the proximal side of the bottom wall and a noise insulating portion distal connecting portion located on the distal side of the bottom wall, the noise insulating portion proximal connecting portion being connected to the bottom wall while being caused to deviate slightly from the proximal side toward the distal side of the bottom wall so that a distal end of an outer panel of the flange can be brought into contact with the bottom wall.

In this aspect of the invention, since the hollow noise insulating portion is connected to the bottom wall at the noise insulating portion proximal connecting portion located on the proximal side of the bottom wall and the noise insulating portion distal connecting portion located on the distal side of the bottom wall, the hollow noise insulating portion covers widely the inner surface of the bottom wall, and even in the event that the flange becomes thick, the hollow noise insulating portion can cover the distal end of the flange assuredly.

Since the noise insulating portion proximal connecting portion is connected to the bottom wall while being caused to deviate slightly from the proximal side toward the distal side of the bottom wall so that the distal end of the outer panel of the flange can be brought into contact with the bottom wall, the distal end of the flange is locked direct to the proximal edge of the bottom wall so as to be held in place thereat without being disrupted by the hollow noise insulating portion, whereby a position where the weather strip is mounted on the flange can be determined assuredly. In addition, since the position of the distal end of the outer panel is determined to be located at the proximal edge of the bottom wall, the mounting position of the mounting base portion of the weather strip on the flange is determined based on the distal end of the outer panel, and therefore, there occurs no case where the mounting position varies.

According to the invention, the exterior side wall may be formed of a solid rubber or sponge rubber.

In this aspect of the invention, when mounted on the flange, the exterior side wall can deform to be bonded so as to follow the shape of the flange of the vehicle body opening peripheral part, so that the hollow seal portion can be positioned in a predetermined position so as to ensure the contact against the door or the like, thereby making it possible to secure the sealing properties.

According to the invention, a cover lip may be formed on an outer surface of the bottom wall so as to cover the bottom wall.

In this aspect of the invention, since the cover lip is formed on the outer surface of the bottom wall so as to cover the bottom wall, the cover lip can cover a gap between a garnish and the base mounting portion so as to make the flange and the mounting base portion invisible from the passenger compartment side, thereby making it possible to improve the appearance of the vehicle.

According to the invention, a decorative layer may be provided on an outer surface of the cover lip.

In this aspect of the invention, the weather strip can be decorated so as to match the color and decoration in the passenger compartment so as to enhance the degree of freedom in design, thereby making it possible to improve the appearance of the vehicle when looked at from the passenger compartment side.

According to the invention, the decorative layer may be formed of any of a nonwoven fabric, woven fabric, fillings, colored thermoplastic elastomer or colored synthetic resin.

In this aspect of the invention, a decorative weather strip can be selected which matches properly the color and touch of the decoration inside the passenger compartment.

### BRIEF DESCRIPTION OF THE DRAWINGS

FIG. 1 is a cross sectional view of an opening trim weather strip according to a first embodiment of the invention which is taken along the line A-A in FIG. 8 in such a state that the opening trim weather strip is mounted on a vehicle body opening peripheral part.

FIG. 2 is a cross sectional view, similar to FIG. 1, of an opening trim weather strip according to a second embodiment of the invention.

FIG. 3 is a cross sectional view, similar to FIG. 1, of an opening trim weather strip according to a third embodiment of the invention.

FIG. 4 is a cross sectional view, similar to FIG. 1, of an opening trim weather strip according to a fourth embodiment of the invention in such a state that the opening trim weather strip is mounted on a flange of a single sheet metal of a vehicle body opening peripheral part.

FIG. 5 is a cross sectional view, similar to FIG. 1, of the opening trim weather strip according to the fourth embodiment of the invention in such a state that the opening trim weather strip is mounted on a flange provided with two sheets of metal of the vehicle body opening peripheral part.

FIG. 6 is a cross sectional view, similar to FIG. 1, of the opening trim weather strip according to the fourth embodiment of the invention in such a state that the opening trim weather strip is mounted on a flange provided with five sheets of metal of the vehicle body opening peripheral part.

FIG. 7 is a perspective view of a side of a motor vehicle.

FIG. 8 is a front view of the opening trim weather strip according to the embodiments of the invention.

FIG. 9 is a cross sectional view of an opening trim weather strip according to a fifth embodiment of the invention which is taken along the line A-A in FIG. 8 in a state resulting before the opening trim weather strip is mounted on a vehicle body opening peripheral part.

FIG. 10 is a cross sectional view of the opening trim weather strip according to the fifth embodiment of the invention which is taken along the line A-A in FIG. 8 in a state where the opening trim weather strip is mounted on the vehicle body opening peripheral part.

FIG. 11 is a cross sectional view of the opening trim weather strip according to the fifth embodiment of the invention which is taken along the line A-A in FIG. 8 in a state where the opening trim weather strip 10 is mounted on a vehicle body opening peripheral part 6 which constitutes a thick flange.

FIG. 12 is a cross sectional view showing a conventional seal construction between a door and a vehicle body opening peripheral part.

FIG. 13 is a partial cross sectional view showing another conventional door opening trim weather strip which is mounted on an opening part of a motor vehicle.

FIG. 14 is a partial cross sectional view showing a further conventional door opening trim weather strip which is mounted on the opening part of the motor vehicle.

FIG. 15 is a partial cross sectional view showing another conventional door opening trim weather strip which is mounted on the opening part of the motor vehicle.

FIG. 16 is a partial cross sectional view showing a further conventional door opening trim weather strip which is mounted on the opening part of the motor vehicle.

### DETAILED DESCRIPTION OF THE PREFERRED EMBODIMENTS

Embodiments of the invention will be described by taking as an example an opening trim weather strip 10. In addition to the opening weather strip 10, the invention can be applied to a weather strip having a seal portion and a mounting base portion such as a sliding roof weather strip, a trunk lid weather strip or a tailgate weather strip which is used on an open/close member for sealing a gap between a vehicle body opening and a vehicle body opening peripheral part of a motor vehicle by covering the opening.

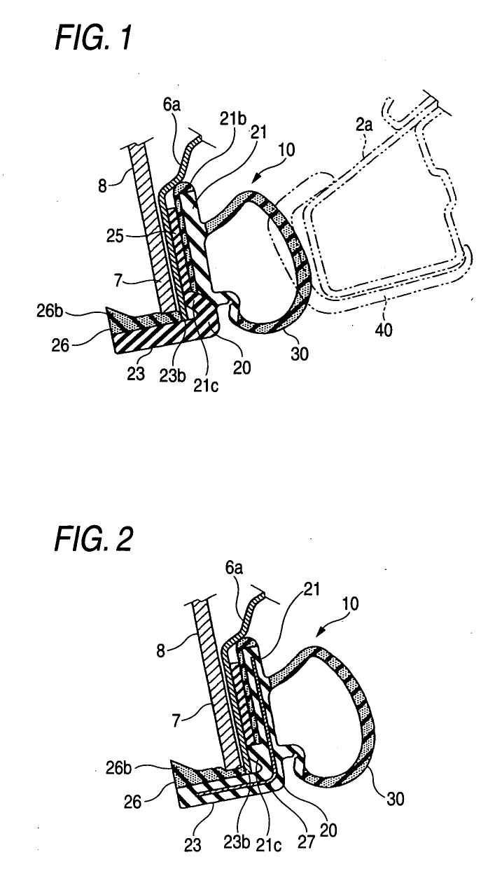

Embodiments of the invention will be described based on FIGS. 1 to 11.

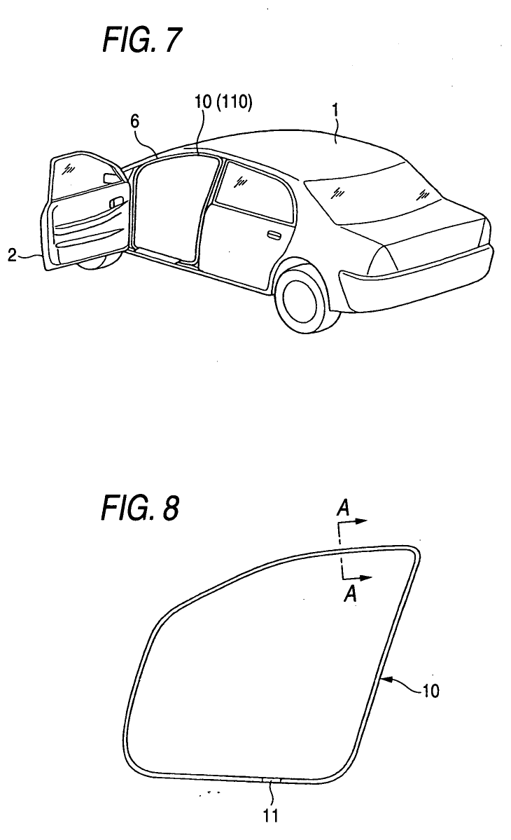

FIG. 1 is a cross sectional view of an opening trim weather strip 10 according to a first embodiment of the invention which is taken along the line A-A in FIG. 8 in such a state that the opening trim weather strip 10 is mounted on a vehicle body opening peripheral part 6 shown in FIG. 7. FIG. 2 is a similar cross sectional view of an opening trim weather strip 10 according to a second embodiment of the invention.

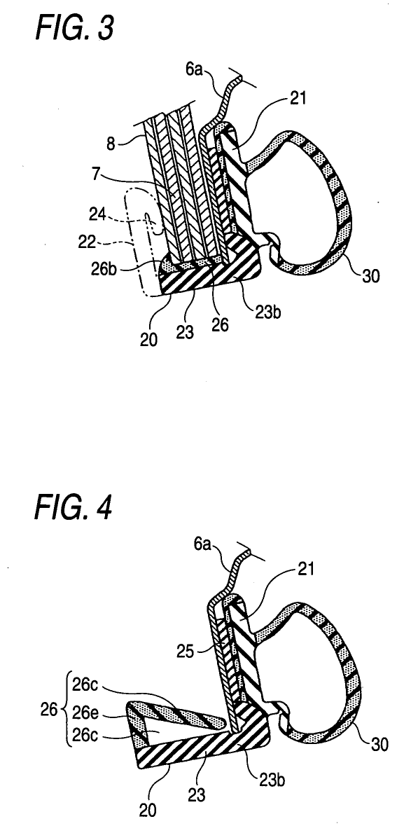

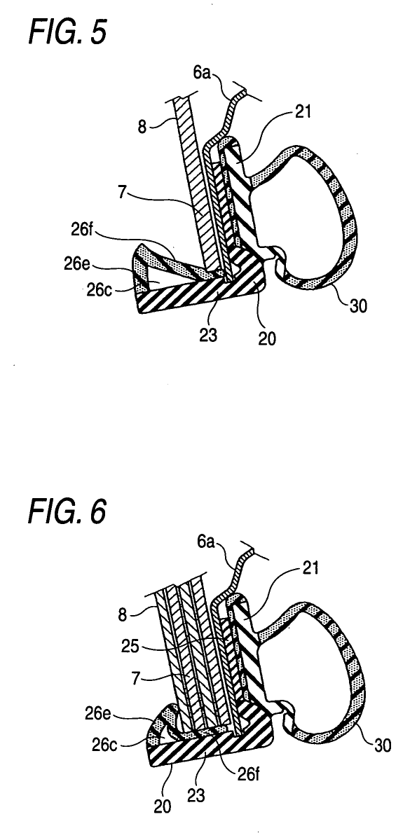

FIG. 3 is a similar cross sectional view of an opening trim weather strip 10 according to a third embodiment of the invention. FIG. 4 is a similar cross sectional view of an opening trim weather strip 10 according to a fourth embodiment of the invention. FIGS. 5 and 6 are similar cross sectional views of the opening trim weather strip according to the fourth embodiment of the invention.

FIG. 7 is a perspective view showing a state in which the opening trim weather strip 10 is mounted on the vehicle body opening peripheral part 6 in such a state that a door of a motor vehicle is opened. FIG. 8 is an overall front view of the opening trim weather strip 10 that is to be mounted on the vehicle body opening peripheral part 6.

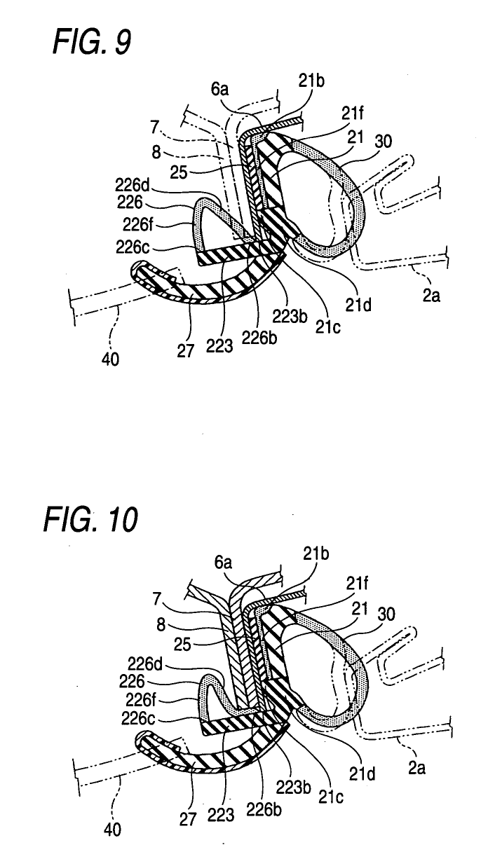

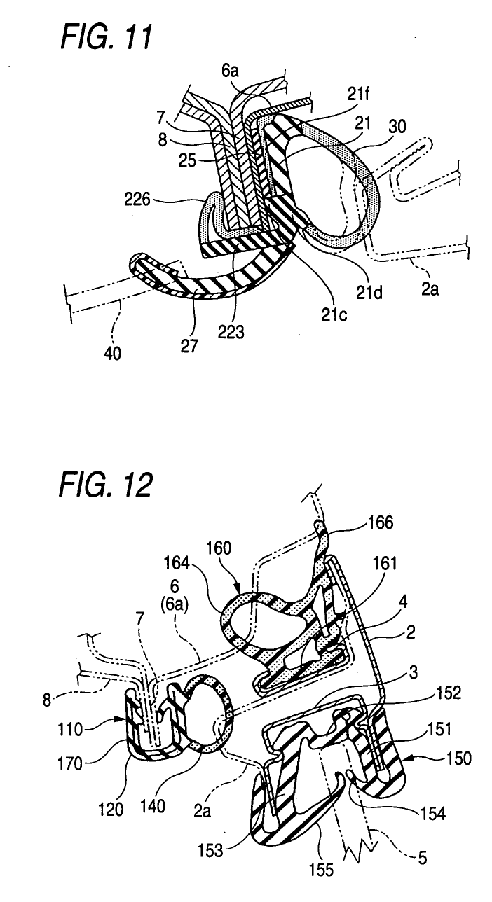

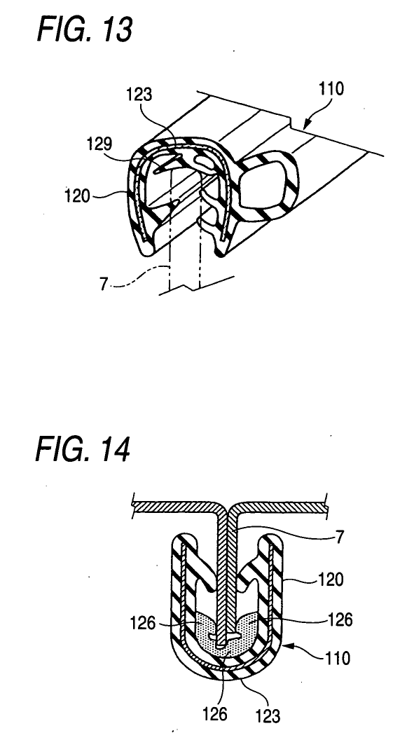

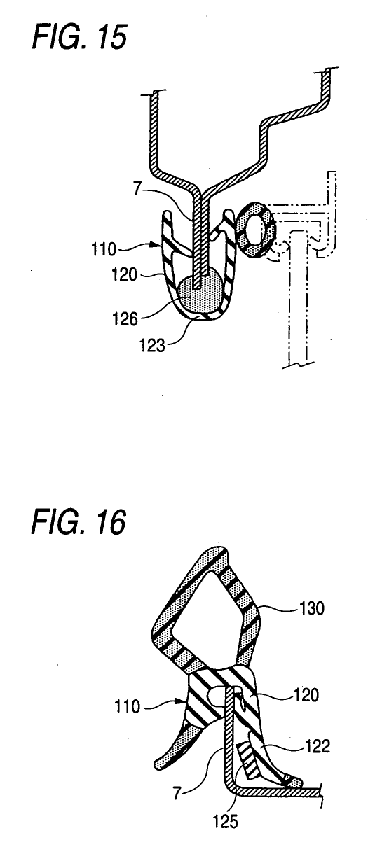

FIG. 9 is a cross sectional view of an opening trim weather strip 10 according to a fifth embodiment of the invention which is taken along the line A-A in FIG. 8 in a state resulting before the opening trim weather strip 10 is mounted on a vehicle body opening peripheral part 6 shown in FIG. 7. FIG. 10 is a similar cross sectional view which shows a state where the opening trim weather strip 10 is mounted on the vehicle body opening peripheral part 6 shown in FIG. 7. FIG. 11 is a similar cross sectional view which shows a state where an inner panel 8 is mounted on a vehicle body opening peripheral part 6 provided with a flange 7 formed of three sheets of metal.

### First Embodiment

As shown in FIG. 7, a vehicle body 1 of a motor vehicle has a vehicle body opening, and the vehicle body opening is opened and closed by a door 2 which is an open/close member for a vehicle body opening. A periphery of the vehicle body opening constitutes a vehicle body opening peripheral part 6, and the vehicle body opening peripheral part 6 forms a flange 7 (refer to FIGS. 1, 3) by welding together end portions of panel members such as an outer panel 6a, an inner panel 8 and the like which constitute the vehicle body. An opening trim weather strip 10 is mounted on the flange 7 which functions as a weather strip of this embodiment which seals a gap between the vehicle body opening peripheral part 6 and the door 2.

On the flange 7, since the number of panels which are welded together varies from one to on the order of five depending on locations on the vehicle body opening peripheral part 6 of the vehicle body 1, the thickness of the flange 7 varies depending on locations of the vehicle body.

The opening trim weather strip 10 is formed into a straight line through extrusion. A single opening trim weather strip 10 that is formed into the straight line is then mounted on the flange 7 along the shape of the vehicle body opening peripheral part 6 so as to become annular, as shown in FIG. 8. When mounted initially, the opening trim weather strip 10 is mounted on the flange 7 sequentially from one terminal end thereof, and when mounted completely, the other terminal end thereof comes to be joined to the one terminal end. As shown in FIG. 8, the terminal ends may be molded together at a connecting portion 11 so as to form the opening trim weather strip 10 into the annular shape.

Alternatively, the terminal ends of the opening trim weather strip 10 may be bonded to each other with an adhesive before mounted on the flange 7 so as to form the opening trim weather strip 10 into the annular shape.

Forming the opening trim weather strip 10 into the annular shape facilitates the mounting thereof on the flange 7.

Next, based on FIG. 1, a cross sectional shape of the opening trim weather strip 10 according to the first embodiment of the invention will be described.

The opening trim weather strip 10 has a trim portion 20 as a mounting base portion having a substantially L-shaped cross section which is to be mounted on the flange 7 and a hollow seal portion 30 as a hollow seal portion which is formed integrally on the trim portion 20 so as to be brought into contact with a door frame projecting portion 2a of the door 2 so as to seal a gap between the door 2 and the vehicle body opening peripheral part 6.

The trim portion 20 is formed so as to have a substantially L-shaped cross section which is provided with an exterior side wall 21 and a bottom wall 23. In order for the trim portion 20 to be enabled to correspond flexibly to a variation in thickness of the flange 7, the bottom wall 23 has a predetermined width. The exterior side wall 21 and the bottom wall 23 of the trim portion 20 are formed integrally and continuously, and no insert (core material) is embedded therein which is formed of a metallic plate or a hard synthetic resin so as to reinforce the holding force with which the flange 7 is held. This enables the reduction in weight of the opening trim weather strip 10.

The exterior side wall 21 is formed so as to have a substantially flat plate-shaped cross section, and a pressure sensitive adhesive double sided tape 25 is bonded to an interior side surface of the exterior side wall 21. The opening trim weather strip 10 is bonded to a side of the flange 7 by the pressure sensitive adhesive double sided tape 25.

When the pressure sensitive adhesive double sided tape 25 is used, since the opening trim weather strip 10 only has to be bonded to the exterior side surface of the flange, even in the event that the thickness of the flange 7 varies, the same mounting method is adopted, the bonding force to the flange 7 remains the same, and the mounting is facilitated. In addition, when the pressure sensitive adhesive double sided tape 25 is adhered to the exterior side wall 21, an adhering area is increased, so as to allow the trim portion 20 to be bonded strongly and rigidly.

In the event that the pressure sensitive adhesive double sided tape 25 is formed of a sponge material to thereby increase the thickness thereof, and part of the exterior side wall 21 is formed of a sponge material, the pressure sensitive adhesive double sided tape 25 and the exterior side wall 21 are allowed to deform so as to match irregularities such as spot marks or the like which are formed on the side surfaces of the flange 7, whereby the double sided tape 25 and the exterior side wall 21 can be brought into tight contact with the flange 7.

A protruding portion 21c may be provided on an interior side surface f the exterior side wall 21 at a portion lying closer to the bottom portion 23. When an edge of the pressure sensitive adhesive double sided tape 25 is adhered along this protruding portion 21c, the positioning of the pressure sensitive adhesive double sided tape 25 is made possible.

A connecting portion between an interior side surface of the exterior side wall 21 and the bottom wall 23 and the vicinity thereof can be formed integrally with the bottom wall 23 using a hard material. In this case, the rigidity of the connecting portion is increased, and when the opening trim weather strip 10 is mounted on the flange 7, being pushed by a distal end of the flange, the bottom wall 23 is prevented from rotating about the connecting portion in a direction in which the bottom wall 23 moves apart from the distal end of the flange or rotating downward as viewed in FIG. 1.

A distal end portion 21b formed of a sponge material is formed integrally along a distal end of the exterior side wall 21. When the exterior side wall 21 is mounted on the flange 7, the distal end portion 21b is brought into contact with a bent portion of the outer panel 6a so as to seal a gap between the outer panel 6a and the opening trim weather strip 10.

The sponge material of the distal end portion 21b can be formed so as to extend from the distal end portion 21b to a surface of the exterior side wall 21 where the pressure sensitive adhesive double sided tape 25 is adhered. In this case, as has been described above, the irregularities such as spot marks formed on the side of the flange 7 can be absorbed further by the sponge material so extended.

The bottom wall 23 is formed substantially into a flat plate-like shape, and a hard material is formed continuously and integrally from the exterior side wall 21 to an end portion of the bottom plate 23 which lies to the interior side of the passenger compartment.

Since the bottom wall 23 is formed of the hard material as a whole, even in the event that the distal end of the flange 7 is brought into contact with the bottom wall 23 to push the same wall, there is little chance of the bottom wall 23 being deformed, and hence a position where the exterior side wall 21 is bonded to the flange 7 can be determined, whereby not only the flange 7 can be locked assuredly but also the distal end of the flange 7 can be brought into contact with a caulking sponge 26 as a caulking member which will be described later on.

A hard rubber or a hard synthetic resin can be used as the hard material, and as the hard rubber, a hard EPDM rubber of JIS HA85 to 95 can be used, while as the hard synthetic resin, a hard polyethylene, polypropylene or the like can be used. Furthermore, a hard olefin-based thermoplastic elastomer of JIS HA85 to 95 can also be used. Since the materials having the aforesaid hardnesses are used as the hard material, the deformation of the trim portion 20 can be prevented with no insert.

In addition, these hard materials deform little, and when the opening trim weather strip 10 is mounted on the flange 7, the hard materials stretch little relative to the flange 7, whereby there occurs no case where part of the opening trim weather strip 10 is caused to float from the flange 7 or the opening trim weather strip 10 is creased.

When extruding the opening trim weather strip 10, in a case where the hard EPDM rubber, the hard material is formed using the hard polyethylene, polypropylene or the like is used as the hard material and the other portions formed using a soft EPDM rubber or olefin-based thermoplastic elastomer, the hard and soft materials can be extruded simultaneously using an extruding machine.

The other portions of the trim portion 20 than the portion formed of the sponge material can be formed of a soft EPDM rubber or olefin-based thermoplastic elastomer of JIS HA60 to 85. Due to this, a sufficient strength to hold the flange 7 and a sufficient flexibility to follow a change in shape of the flange 7 can be provided together.

A stepped portion 23b is formed on an inner surface of the bottom wall 23 at a position in the vicinity of a connecting portion with the exterior side wall 21 so that the distal end of the flange 7 is locked therewith. The stepped portion 23b may be formed into a step-like shape having an L-shaped cross section on the bottom wall 23, or as shown in FIG. 1, the stepped portion 23 may be formed by a side of a caulking sponge 26 and the inner surface of the bottom wall 23.

The distal end of the flange 7 or the distal end of the outer panel 6a in this embodiment is brought into contact with a portion on a bottom of the stepped portion 23b and a side of a distal end portion of the outer panel 6a is brought into contact with a portion on a side of the stepped portion 23b, whereby the distal end of the outer panel 6a is locked, and the position where the opening trim weather strip 10 is mounted on the flange 7 can be determined assuredly.

In a case where the bottom wall 23 including the stepped portion 23b is formed of the hard rubber, even in the event that the distal end of the outer panel 6a is brought into contact with the stepped portion 23b, since the stepped portion 23 has a sufficient hardness, the stepped portion 23 deforms little.

The caulking sponge 26 which is a caulking member is provided on the inner surface of the bottom wall 23. Other materials than the sponge material may be used as the caulking member as long as the materials are such as to encapsulate and seal the distal end of the flange 7. The caulking sponge 26 is provided from an interior end portion 26b of the bottom wall 23 to the vicinity of the stepped portion 23b and is formed such that the distal end of the outer panel 6a, which constitutes the longest edge of the flange 7, can be brought into contact with the stepped portion 23b.

The caulking sponge 26 is formed so as to protrude, upward in FIG. 1, largely (high) from the bottom wall 23 at the interior end portion 26b so as to have a substantially triangular cross section. Due to this, even in the event that being pushed by the distal end of the flange 7 after the trim portion 20 is mounted on the flange 7, the bottom wall 23 rotates about its connecting portion with the exterior side wall 21 in a direction in which the bottom wall 23 moves apart (downward) to deform, the caulking sponge 26 is formed to be high at the interior end portion 26b, and hence, there occurs no case where the caulking sponge 26 is separated from the distal end of the flange 7, whereby neither noise nor rain water leaks from the distal end of the flange 7, thereby making it possible to secure the sealing properties.

In addition, since the caulking sponge 26 is formed so as to protrude from the bottom wall to a largest extent (highest) at an interior edge thereof, the caulking sponge 26 is brought into contact with the side of the flange 7 at this particular portion, thereby there occurring no case where noises or the like intrude into the interior of the passenger compartment.

A hollow portion 26c may be formed in this thick portion lying at the interior side of the caulking sponge 26. As this occurs, the flexibility of the caulking sponge 26 is increased, and this allows an interior edge of the flange 7 to enter the interior of the caulking sponge 26 deeper so as to enhance the sealing properties.

The hollow seal portion 30, which functions as a seal portion, is provided integrally on an outer surface of the exterior side wall. The hollow seal portion 30 is formed of a hollow sponge material having a substantially oval cross section on the outer surface of the exterior side wall 21. A sponge rubber, sponge thermoplastic elastomer or the like is used for the sponge material. The hollow seal portion 30 is, when the door is closed, for example, brought into contact with the projecting portion 2a of the door frame so as to seal a gap between the door 2 and the vehicle body opening peripheral part 6. A garnish 40 may be attached to the projecting portion 2a of the door frame of the door 2 in order to improve the appearance of the vehicle, and as this occurs, the hollow seal portion 30 is then brought into contact with the garnish 40 so attached. The hollow seal portion 30 can be formed on an outer surface of the bottom wall 23 depending on the position of a mating member with which the hollow seal portion 30 is brought into contact.

In place of the hollow seal portion 30, a lip-shaped seal portion may be provided on the outer surface of the exterior side wall 21 as the seal portion.

When the opening trim weather strip 10 of the first embodiment is mounted on the flange 7, firstly, the trim portion 20 of the opening trim weather strip 10 is positioned obliquely relative to the flange 7, so that the distal end of the outer panel 6a of the flange is brought into contact with the bottom wall 23. As this occurs, since no interior side wall 22 exists on the trim portion 20, the flange 7 can be inserted while being caused to fall obliquely relative to the trim portion 20.

As this occurs, since the outer panel 6a which lies laterally most outward among the panels making up the flange 7 is made slightly longer than the other panels, the distal end thereof comes into contact with the stepped portion 23b of the bottom wall 23. As this occurs, a side of the outer panel 6a is brought into contact with the protruding portion 21c of the exterior side wall 21, and the pressure sensitive adhesive double sided tape 25 is bonded to the side of the outer panel 6a.

### Second Embodiment

Next, a second embodiment of the invention will be described with respect to a cross sectional shape of an opening weather strip 10 based on. FIG. 2. The second embodiment differs from the first embodiment in that a cross sectional shape of a caulking sponge 26 is formed into a step-like shape and that an insert member 27 is embedded in a trim portion 20 and an exterior side wall 21 and a bottom wall 23 are formed of the same material, and hence, these different features will mainly be described while omitting the description of similar parts thereof to those of the first embodiment.

While the caulking sponge 26 is formed of a soft material such as a sponge material as in the case with the first embodiment, the caulking sponge 26 is formed, in cross section, so as to be stepped sequentially from a stepped portion 23b of the bottom wall 23 to an interior end portion 26b thereof. Due to this, even in the event that the bottom wall 23 rotates about its connecting portion with the exterior side wall 21 to deflect, the caulking sponge 26 which is formed into the step-like shape can encapsulate the distal end of the flange 7 to thereby come into tight contact the distal end, thereby making it possible to secure the sealing properties.

The insert member 27 can be embedded in the exterior side wall 21 and the bottom wall 23. In this case, the rigidity of the exterior side wall 21 and the bottom wall 23 is increased, and hence, there is little chance of the exterior side wall 21 and the bottom wall 23 being deformed after the trim portion 20 is mounted on the flange 7. In addition, there occurs no case where the bottom wall 23 rotates about the connecting portion between the exterior side wall 21 and the bottom wall 23 to deform, thereby making it possible to secure the sealing properties between the distal end of the flange 7 and the caulking sponge 26 of the bottom wall 23. Since a normal solid material, not a hard material, can be used for the exterior side wall 21 and the bottom wall 23, the number of kinds of materials can be reduced, thereby facilitating the extrusion of the opening trim weather strip 10.

Furthermore, the insert member 27 deforms little, and hence, when the opening trim weather strip 10 is mounted on the flange 7, the insert member 27 stretches little relative to the flange 7, whereby there is little chance of the opening trim weather strip 10 being caused to partially float from the flange 7 of the vehicle body opening peripheral part 6 or being creased.

### Third Embodiment

Next, a third embodiment of the invention will be described with respect to a cross sectional shape of an opening weather strip 10 based on FIG. 3. The third embodiment differs from the first embodiment in that an interior end portion 26b of a caulking sponge 26 is formed so as to protrude to cover a distal end of a flange 7 and that an interior side wall 22 can be formed on a trim portion 20, and hence, these different features will mainly be described while omitting the description of similar parts thereof to those of the first embodiment. In addition, in FIG. 3, the flange 7 of the third embodiment is formed by welding together many panels or five panels including an outer panel 6a and an inner panel 8, and the trim portion 20 is bonded to distal ends of the panels of the flange 7.

As of the first embodiment, the caulking sponge 26 is formed of a soft material such as a sponge material. The caulking sponge 26 is formed to have substantially the same cross section from a stepped portion 23b of a bottom wall 23 to the vicinity of the interior end portion 26b thereof, and the interior end portion 26b is formed in cross section so as to protrude upward as viewed in FIG. 3, while a side of the interior end portion 26b which faces an interior edge of the flange 7 is formed into a substantially flat surface in cross section so as to be brought into contact with the interior edge of the flange 7. When the trim portion 20 is mounted on the flange 7, an interior end portion of the flange 7 pushes on the caulking sponge 26, causing the interior end portion 26b of the caulking sponge 26 to encapsulate a distal end portion of the flange 7, and therefore, even in the event that the bottom wall 23 rotates about its connecting portion with the exterior side wall 21 in a direction in which the bottom wall 23 moves apart from the flange 7 (downward) to deform, the caulking sponge 26 is allowed to remain in tight contact with the distal end of the flange 7 to thereby effect sealing.

In addition, as shown in FIG. 3, the trim portion 20 may be formed to have a substantially U-shaped cross section which is defined by the exterior side wall 21, the interior side wall 22 and the bottom wall 23. In this case, the exterior side wall 21, the interior side wall 22 and the bottom wall 23 are formed integrally and continuously with no insert member embedded therein which is formed of a metallic plate or hard synthetic resin adapted to reinforce the holding force to hold the flange. Due to this, the trim portion 20 can deform flexibly according to the shape of the flange 7.

In the event that the trim portion 20 is formed to have the substantially U-shaped cross section, an interior holding lip 24 is formed on a distal end of the interior side wall 22 so as to extend obliquely from the distal end of the interior side wall 22 in a direction of an interior of the trim portion 20, so that the interior holding lip 24 can be brought into contact with a side of the flange 7. Due to this, the interior side surface of the flange 7 can be sealed, and the flange 7 can be held by the interior holding lip 24 together with the exterior side wall 21. Furthermore, even in the event that the thickness of the flange varies, the interior holding lip 24 can deflect so as to match the variation in thickness, thereby making it possible to secure the holding properties, as well as the sealing properties.

### Fourth Embodiment

Next, a fourth embodiment of the invention will be described with respect to a cross sectional shape of an opening weather strip 10 based on FIGS. 4 to 6. The fourth embodiment differs from the first embodiment in that a caulking sponge 26 is positioned at an interior end portion of a bottom wall 23, in which a first lip-like portion 26e is provided so as to extend substantially in parallel to the exterior side wall in a direction of an inner surface side of the bottom wall 23 forming a wall, while a second lip-like portion 26f is provided so as to extend obliquely from a distal end of the first lip-like portion 26e toward a connecting portion between the bottom wall 23 and the exterior side wall 21, and hence, these different features will mainly be described while omitting the description of similar parts thereof to those of the first embodiment.

The caulking sponge 26 is such that in FIG. 4, the wall-like first lip-like portion 26e is formed to extend upward from an upper surface of the interior end portion of the bottom wall 23, while the second lip-like portion 26f is formed to extend obliquely from the distal end of the first lip-like portion 26e toward the connecting portion between the bottom wall 23 and the exterior side wall 21. An empty space portion 26c, which has a substantially triangular cross section and which is made larger at an interior side of the passenger compartment, is formed between the bottom wall 23 and the first and second lip-like portions 26e, 26f.

In the event that the flange 7 is provided with a single panel, that is, the outer panel 6a, as shown in FIG. 4, the distal end of the outer panel 6a comes into contact with a stepped portion 23b of the bottom wall 23, while the trim portion 20 is bonded to the side of the outer panel by the pressure sensitive adhesive double sided tape 25. In this case, although the caulking sponge 26 is not brought into contact with the side of the outer panel 6a, since the distal end of the flange 7 is in contact with the stepped portion 23b of the bottom wall 23 assuredly, there occurs no case where noises or the like intrude into the interior of the passenger compartment, thereby making it possible to secure the sealing properties.

In the event that the flange 7 is formed by welding together two panels such as the outer panel 6a and the inner panel 8, as shown in FIG. 5, the distal end of the outer panel 6a is brought into contact with the stepped portion 23b of the bottom wall 23 in an interior of the stepped portion 23b, while a distal end of the inner panel 8 is brought into contact with a distal end of the second lip-like portion 26f of the caulking sponge 26. Due to this, even in the event that a gap exists between the outer panel 6a and the inner panel 8 due to a spot mark, the second lip-like portion 26f covers the gap so as to secure the sealing properties.

In the event that the flange 7 is thick due to several panels including the outer panel 6a and the inner panel 8 being welded together, as shown in FIG. 6, the distal end of the outer panel 6a is brought into contact with the stepped portion 23b of the bottom wall 23 in an interior of the stepped portion 23b, while distal ends of the plurality of panels of the flange 7 are brought into contact with the whole of the second lip-like portion 26f of the caulking sponge 26. As this occurs, since the caulking sponge 26 has the empty space 26c between the bottom wall 23 and itself, the caulking sponge 26 can deform so flexibly as to seal the distal end of the flange 7. Also with the flange 7 provided with the plurality of panels, similar to the aforesaid case where the flange 7 is provided with the two panels, even in the event that gaps exist between the plurality of panels, respectively, due to spot marks, the second lip-like portion 26f is brought into contact with the distal ends thereof so as to cover the gaps so as to secure the sealing properties.

In addition, since the empty space 26c at the interior side of the caulking sponge 26 is large, the interior edge of the flange 7 is brought into strong elastic contact with the second lip-like portion 26f, and hence, there occurs no case where noises or the like intrude into the interior of the passenger compartment, thereby making it possible to secure the sealing properties.

Furthermore, when the trim portion 20 is mounted on the flange 7, the distal end of the first lip-like portion 26e is pulled by the second lip-like portion 26f to thereby be brought into contact with an edge of the inner panel 8 so as to enhance the sealing properties. Due to this, even in the event that the bottom wall 23 rotates about its connecting portion with the exterior side wall 21 in the direction in which the bottom wall 23 moves apart from the flange 7 (downward) to deform, the first and second lip-like portions 26e, 26f of the caulking sponge 26 are so flexible as to be brought into tight contact with the edge of the flange 7 to thereby seal the same edge.

In the opening trim weather strip 10 according to the first to fourth embodiments of the invention, when the hollow seal portion 30 is formed of the sponge material such as EPDM rubber or olefin-based thermoplastic elastomer, the other portions of the trim portion 20 than the portion which is made of the hard material are formed of the solid material or finely foamed material of EPDM rubber or olefin-based thermoplastic elastomer, and the portion of the trim portion 20 which is formed of the hard material is formed of the solid material of EPDM rubber or olefin-based thermoplastic elastomer, a product can be obtained which has good weathering properties. In addition, the opening trim weather strip 10 is olefin based as a whole, and hence, it can be ground altogether to be recycled for reuse.

Next, a manufacturing method of the door opening trim weather strip 10 (as described in the first to fourth embodiments) will be described.

This door opening trim weather strip 10 is made through extrusion, and the solid rubber making up the trim portion 20 and the sponge rubber making up the hollow seal portion 30 and the caulking sponge 26 can be extruded integrally by an extruder.

When the insert member 27 is embedded in the trim portion 20, the insert member 27 is extruded together with the trim portion 20 and the like.

In the extrusion of the opening trim weather strip 10, with respect to the extruding materials, for the solid material or finely foamed material, a polyolefin-based elastomer is used as the thermoplastic elastomer. As the sponge material, the aforesaid EPDM rubber or the thermoplastic elastomer is used and is made to be foamed.

For the hard material, a polyethylene resin, polypropylene resin, hard rubber, hard thermoplastic elastomer or the like can be used.

In the case of a synthetic rubber, after extrusion, an extruded rubber is transferred to a vulcanization tank and is then heated by hot air or high-frequency wave for vulcanization and foaming. In the case of the thermoplastic elastomer and the soft synthetic resin, the resin is heated to be foamed at the same time as or after extrusion and is then cooled to be set. Thereafter, the set resin is cut into a predetermined length, whereby the extrusion of the extruded portion is completed.

The extruded opening trim weather strip 10 may be cut into a predetermined length and then connected together at ends thereof so as to be formed into an annular shape, and the annular opening trim weather strip 10 is then mounted on the flange 7.

### Fifth Embodiment

Next, a fifth embodiment of the invention will be described with respect to a cross sectional shape of an opening weather strip 10 based on FIGS. 9 to 11. Different features from the above embodiments will mainly be described while omitting the description of similar parts thereof to those of the above embodiments.

The exterior side wall 21 is formed so as to have a substantially flat plate-shaped cross section, and a pressure sensitive adhesive double sided tape 25 is bonded to an interior side surface of the exterior side wall 21. The opening trim weather strip 10 is bonded to a side of the flange 7 by the pressure sensitive adhesive double sided tape 25.

When the pressure sensitive adhesive double sided tape 25 is used, since the opening trim weather strip 10 only has to be bonded to the exterior side surface of the flange, even in the event that the thickness of the flange 7 varies, the same mounting method is adopted, the bonding force to the flange 7 remains the same, and the mounting is facilitated. In addition, when the pressure sensitive adhesive double sided tape 25 is adhered to the exterior side wall 21, an adhering area is increased, so as to allow the trim portion 20 to be bonded strongly and rigidly.

In the event that the pressure sensitive adhesive double sided tape 25 is formed of a sponge material to thereby increase the thickness thereof or a bonding portion 21f on a surface of the exterior side wall 21 to which the pressure sensitive adhesive double sided tape is adhered is formed of a sponge material, the pressure sensitive adhesive double sided tape 25 cannot only be brought into tight contact with the exterior side wall 21 but also be allowed to deform so as to match irregularities such as spot marks or the like which are formed on the side surfaces of the flange 7 so as to be brought into tight contact with the exterior side wall 21.

A protruding portion 21c may be provided on an interior side surface of the exterior side wall 21 at a portion lying closer to the bottom portion 223. When an edge of the pressure sensitive adhesive double sided tape 25 is adhered along this protruding portion 21c, the positioning of the pressure sensitive adhesive double sided tape 25 is made possible.

A connecting portion 21d between the exterior side wall 21 and the bottom wall 223 and the vicinity thereof can be formed integrally with the bottom wall 223 using a hard material. In this case, the rigidity of the connecting portion is increased, and when the opening trim weather strip 10 is mounted on the flange 7, being pushed by a distal end of the flange 7, the bottom wall 23 is prevented from rotating about the connecting portion 21d in a direction in which the bottom wall 223 moves apart from the distal end of the flange 7 or rotating downward largely as viewed in FIG. 9.

A distal end portion 21b formed of a sponge material is formed integrally along a distal end of the exterior side wall 21. When the exterior side wall 21 is mounted on the flange 7, the distal end portion 21b is brought into contact with a bent portion of the outer panel 6a so as to seal a gap between the outer panel 6a and the opening trim weather strip 10.

The sponge material of the distal end portion 21b can be formed so as to extend from the distal end portion 21b to the bonding portion 21f of the exterior side wall 21 where the pressure sensitive adhesive double sided tape 25 is adhered. In this case, as has been described above, the pressure sensitive adhesive double sided tape 25 and the exterior side wall 21 can be brought into tight contact with each other, and the irregularities such as spot marks formed on the side of the flange 7 can be absorbed further by the sponge material so extended.

The bottom wall 223 is formed substantially into a flat plate-like shape, and a hard material is formed continuously and integrally from the connecting portion 21d of the exterior side wall 21 to an end portion of the bottom wall 223 which lies to the interior of the passenger compartment.

Since the bottom wall 223 is formed of the hard material as a whole, even in the event that the distal end of the flange 7 is brought into contact with the bottom wall 223 to push the same wall, there is little chance of the bottom wall 223 being deformed, and hence a position where the exterior side wall 21 is bonded to the flange 7 can be determined, whereby not only the flange 7 can be locked assuredly but also the distal end of the flange 7 can be brought into contact with a hollow noise insulating portion 226 as a seal member which will be described later on.

While the hollow noise insulating portion 226 is formed on an inner surface of the bottom wall 223 as will be described later on, a flange contact portion 223b which constitutes a portion where the hollow noise insulating portion 226 is not formed resides on the inner surface of the bottom wall 223 at a position lying in the vicinity of the connecting portion 21d with the exterior side wall 21. Namely, since an edge of the hollow noise insulating portion 226 which lies on the proximal side thereof (a noise insulating portion proximal connecting portion 226b) is connected to a portion which deviates slightly from the proximal side to the distal side of the bottom wall 223, the flange contact portion 223b results where the inner surface of the bottom wall 223 is exposed.

As shown in FIG. 9, a flange contact portion 223 which holds the distal end of the flange 7 may be formed by a side surface in a distal part of the hollow noise insulating portion 226 and the inner surface of the bottom wall 223. Alternatively, a flange contact portion 223b may be formed on the bottom wall 223 into a step-like shape having an L-shaped cross section or recessed groove-like shape.

The distal end of the flange 7, or the distal end of the outer panel 6a in this embodiment is brought into contact with the portion on the bottom wall 223 where the flange contact portion 223b resides, while a side of a distal end portion of the outer panel 6a is brought into contact with a portion on a side of the flange contact portion 223b, whereby the distal end of the outer panel 6a is held. By adopting this configuration, the position where the opening trim weather strip 10 is mounted on the flange 7 can be determined assuredly.

In the event that the bottom wall 223 including the flange contact portion 223b is formed of a hard rubber, even in the event that the distal end of the outer panel 6a is brought into contact with the flange contact portion 223b, since a sufficient hardness is provided, the bottom wall 223 deforms little.

The hollow noise insulating portion 226 which is a seal member is provided on the inner surface of the bottom wall 223. As the seal member, any other materials than a sponge material can be used, provided that the materials are so flexible as to encapsulate to seal the distal end of the flange 7. However, the sponge material is preferable since it is rich in flexibility. The hollow noise insulating portion 226 is provided from a distal end to the flange contact portion 223b of the bottom wall 223 and is formed such that a distal end of the inner panel 8 of the flange 7 can be brought into contact with the hollow noise insulating portion 26 assuredly.

The hollow noise insulating portion 226 is formed into an empty space having a substantially triangular cross section. A noise insulating portion erect wall 226f is formed on the inner surface of the bottom wall 223 along the distal end thereof so as to extend upward substantially perpendicularly or curve in a direction of the exterior side wall 21 as viewed in FIG. 9, and a noise insulating portion slope 226d is provided so as to extend from a distal end of the noise insulating portion erect wall 226f to the vicinity of the portion (the flange contact portion 223b) which deviates slightly further distally than the connecting portion of the bottom wall 223 with the exterior side wall 21.

Due to this, even in the event that being pushed by the distal end of the flange 7 after the trim portion 20 is mounted on the flange 7, the bottom wall 223 rotates about its connecting portion with the exterior side wall 21 in a direction in which the bottom wall 223 moves apart (downward) to deform, the noise insulating portion 226 is formed to be high at the noise insulating portion erect wall 226f, and hence, there occurs no case where the noise insulating portion 226 is separated from the distal end of the flange 7, whereby neither noise nor rain water leaks from the distal end of the flange 7, thereby making it possible to secure the sealing properties.

In addition, in the flange 7, normally, the distal end of the outer panel 6a which lies to the exterior of the vehicle is formed longest while the inner panel 8 is formed shorter than the distal end of the outer panel 6a. However, since the distal end of the outer panel 6a is provided with the distal ends of the plurality of panels making up the flange 7, the dimension of the distal end thereof may vary. However, since the hollow noise insulating portion 226 is formed into the large hollow shape, the hollow noise insulating portion 226 can absorb the variation so as to encapsulate the distal end of the flange 7 assuredly.

In addition, since the noise insulating portion erect wall 226f of the hollow noise insulating portion is formed high, as shown in FIG. 10, a distal end of the noise insulating portion erect wall 226f is pushed to curve by the flange 7, where the noise insulating portion erect wall 226f is brought into contact with an edge of the flange to thereby prevent the intrusion of noise into the interior of the passenger compartment. In addition, since the hollow noise insulating portion 226 is hollow, the flexibility thereof is enhanced, the interior edge of the flange 7 is allowed to enter the hollow noise insulating portion 226 deeper so as to be encapsulated therein, thereby making it possible to enhance the sealing properties.

In addition, in the event that the flange 7 is formed by welding together two panels such as the outer panel 6a and the inner panel 8, as shown in FIG. 8, the distal end of the outer panel 6a is brought into contact with the flange contact portion 223b of the bottom wall 223 in an interior of the flange contact portion 223b, while the distal end of the inner panel 8 is brought into contact with a distal end of the hollow noise insulating portion 226. Due to this, even in the event that a gap exists between the outer panel 6a and the inner panel 8 due to a spot mark, the noise insulating portion erect wall 226f covers the gap so as to secure the sealing properties.

In the event that the flange 7 is thick due to several panels including the outer panel 6a and the inner panel 8 being welded together, as shown in FIG. 12, the distal end of the outer panel 6a is brought into contact with the flange contact portion 223b of the bottom wall 223 in an interior of the flange contact portion 223b, while the distal ends of the plurality of panels of the flange 7 are brought into contact with the whole of the noise insulating portion slope 226d of the hollow noise insulating portion 226. As this occurs, since the hollow noise insulating portion 226 has the empty space 226c between the bottom wall 223 and itself, the hollow noise insulating portion 226 can deform so flexibly as to seal the distal end of the flange 7. Also with the flange 7 provided with the plurality of panels, similar to the aforesaid case where the flange 7 is provided with the two panels, even in the event that gaps exist between the plurality of panels, respectively, due to spot marks, the hollow noise insulating portion 226 is brought into contact with the distal ends thereof so as to cover the gaps so as to secure the sealing properties.

In addition, since the empty space 226c at the interior side of the hollow noise insulating portion 226 is large, the interior edge of the flange 7 is brought into strong elastic contact with the noise insulating portion slope 226d of the hollow noise insulating portion 226, and hence, there occurs no case where noises or the like intrude into the interior of the passenger compartment, thereby making it possible to secure the sealing properties.

A cover lip 27 is formed into an arc-like shape so as to cover the bottom wall 223 from the outer surface at the proximal edge of the bottom wall 223. A distal end of the cover lip 27 is brought into contact with a garnish 40. Since the cover lip 27 and the garnish 40 are provided, a gap between the garnish 40 and the trim portion 20 can be covered so that the flange 7 and the bottom wall 223 of the trim portion 20 can be made invisible from the passenger compartment side, thereby making it possible to improve the appearance of the vehicle.

In addition, a decorative layer can be provided on an outer surface of the cover lip 27. This decorative layer can be formed so as to match the color and decoration in the passenger compartment so as to enhance the degree of freedom in design of the opening trim weather strip 10, thereby making it possible to improve the appearance of the vehicle when looked at from the passenger compartment side.

This decorative layer can be selected freely among a nonwoven fabric, a woven fabric, fillings, a colored thermoplastic elastomer and a colored synthetic resin. Due to this, a decorative weather strip can be selected which matches the color and touch of the decoration inside the passenger compartment.

The hollow seal portion 30, which functions as a seal portion, is provided integrally on an outer surface of the exterior side wall. The hollow seal portion 30 is formed of a hollow sponge material having a substantially oval cross section on the outer surface of the exterior side wall 21. A sponge rubber, sponge thermoplastic elastomer or the like is used for the sponge material. The hollow seal portion 30 is, when the door is closed, for example, brought into contact with the projecting portion 2a of the door frame so as to seal a gap between the door 2 and the vehicle body opening peripheral part 6. A garnish 40 may be attached to the projecting portion 2a of the door frame of the door 2 in order to improve the appearance of the vehicle, and as this occurs, the hollow seal portion 30 is then brought into contact with the garnish 40 so attached. The hollow seal portion 30 can be formed on an outer surface of the bottom wall 223 depending on the position of a mating member with which the hollow seal portion 30 is brought into contact.

In place of the hollow seal portion 30, a lip-shaped seal portion may be provided on the outer surface of the exterior side wall 21 as the seal portion.

When the opening trim weather strip 10 of the embodiment of the invention is mounted on the flange 7, firstly, the trim portion 20 of the opening trim weather strip 10 is positioned obliquely relative to the flange 7, so that the distal end of the outer panel 6a of the flange is brought into contact with the bottom wall 223. As this occurs, since no interior side wall 22 exists on the trim portion 20, the flange 7 can be inserted while being caused to fall obliquely relative to the trim portion 20.

As this occurs, since the outer panel 6a which lies laterally most outward among the panels making up the flange 7 is made slightly longer than the other panels, the distal end thereof comes into contact with the flange contact portion 223b of the bottom wall 223. As this occurs, a side of the outer panel 6a is brought into contact with the protruding portion 21c of the exterior side wall 21, and the pressure sensitive adhesive double sided tape 25 is bonded to the side of the outer panel 6a.

As shown in FIG. 10, when the opening trim weather strip 10 is mounted on the flange 7, as has been described before, the distal end of the outer panel 6a is brought into contact with the flange contact portion 223b, and the distal end of the inner panel 8 is brought into contact with the hollow noise insulating portion 226, so that the distal end of the inner panel 8 can be encapsulated, whereby the distal end of the flange 7 can be sealed.

In addition, as shown in FIG. 11, even in the event that the flange 7 is formed thick as in a case where the inner panel 8 is provided with three sheets of metal, the hollow noise insulating portion 226 is formed as hollow, and hence, the noise insulating portion slope 226d of the hollow noise insulating portion 226 can deform flexibly so as to encapsulate the distal end of the inner panel 8 assuredly, thereby making it possible to enhance the sealing properties.

In the opening trim weather strip 10 according to the embodiment of the invention, when the hollow seal portion 30 is formed of the sponge material such as EPDM rubber or olefin-based thermoplastic elastomer, the other portions of the trim portion 20 than the portion which is made of the hard material are formed of the solid material or finely foamed material of EPDM rubber or olefin-based thermoplastic elastomer, and the portion of the trim portion 20 which is formed of the hard material is formed of the solid material of EPDM rubber or olefin-based thermoplastic elastomer, a product can be obtained which has good weathering properties. In addition, the opening trim weather strip 10 is olefin based as a whole, and hence, it can be ground altogether to be recycled for reuse.

Next, a manufacturing method of the door opening trim weather strip 10 according to the fifth embodiment will be described.

This door opening trim weather strip 10 is made through extrusion, and the solid rubber making up the trim portion 20 and the sponge rubber making up the hollow seal portion 30 and the hollow noise insulating portion 226 can be extruded integrally by an extruder.

When the insert member is embedded in the trim portion 20, the insert member is extruded together with the trim portion 20 and the like. Thereafter, the insert member and the trim portion which are so extruded are vulcanized and cut by a normal method.

What is claimed is:

1. A weather strip for sealing a gap between an open/close member for a vehicle body opening and a peripheral part of the vehicle body opening, the weather strip comprising:
a mounting base portion adapted to be mounted on a flange provided on one of the open/close member and the peripheral part of the vehicle body opening; and
a seal portion provided integrally on the mounting base portion to be brought into contact with the other of the open/close member and the peripheral part of the vehicle body opening so as to seal the gap between the open/close member and the peripheral part of the vehicle body opening,
wherein the mounting base portion is provided with at least a bottom wall and an exterior side wall, and
a pressure sensitive adhesive double sided tape is adhered to an interior side surface of the exterior side wall, and a caulking member is mounted on an inner surface of the bottom wall, the caulking member being formed such that an interior end portion of the caulking member protrudes from the bottom wall more largely than any other portions thereof.

2. A weather strip according to claim 1, wherein the bottom wall is formed of a hard material.

3. A weather strip according to claim 1, wherein an insert member is embedded within the exterior side wall and the bottom wall.

4. A weather strip according to claim 1, wherein the caulking member is formed so as to increase gradually the protruding amount thereof in a slope-like manner from an exterior end portion to an interior end portion of the bottom wall.

5. A weather strip according to claim 1, wherein the caulking member is formed so as to increase sequentially the protruding amount thereof in a stepped manner from an exterior end portion to an interior end portion of the bottom wall.

6. A weather strip according to claim 1, wherein the caulking member has an empty space between the bottom wall and the caulking member or in the caulking member along an interior end portion of the bottom wall.

7. A weather strip according to claim 1, wherein the caulking portion has a first lip-like portion which is provided at a position along an interior end portion of the bottom wall so as to extend substantially in parallel to the exterior side wall toward an inner surface side of the bottom wall and a second lip-like portion which is provided so as to extend obliquely from a distal end of the first lip-like portion toward a connecting portion between the bottom wall and the exterior side wall.

8. A weather strip according to claim 1, wherein a stepped portion with which a distal end of the flange is locked is formed in a vicinity of a connecting portion between the inner surface of the bottom wall and the exterior side wall.

9. A weather strip according to claim 1, wherein the mounting base portion is further provided with an interior side wall, so that the exterior side wall, interior side wall and the bottom wall forms a substantially U-shaped cross section, and an interior holding lip is provided so as to extend obliquely from a distal end of the interior side wall in a direction of an interior of the substantially U-shaped cross section, so that the interior holding lip is brought into contact with a side of the flange.

10. A weather strip according to claim 1, wherein the open/close member is a door and the weather strip is an opening trim weather strip.

11. A weather strip according to claim 1, wherein the seal portion and the caulking member of the weather strip are formed of an EPDM rubber or a sponge material of an olefin-based thermoplastic elastomer, and the mounting base portion is formed of an EPDM rubber, or a solid material or finely foamed material of an olefin-based thermoplastic elastomer.

12. A weather strip affording to claim 1, wherein the bottom wall is formed of a hard member, and a hollow noise insulating portion is formed on an inner surface of the bottom wall, the hollow noise insulating portion being formed of a soft member to have a substantially triangular cross section with a side thereof with which the flange is brought into contact so as to form a slope which is higher along a distal side and is lower along a proximal side of the bottom wall.

13. A weather strip according to claim 12, wherein the hollow noise insulating portion is connected to the bottom wall at a noise insulating portion proximal connecting portion located on a proximal side of the bottom wall and a noise insulating portion distal connecting portion located on the distal side of the bottom wall, the noise insulating portion proximal connecting portion being connected to the bottom wall and being caused to deviate slightly from the proximal side toward the distal side of the bottom wall so that a distal end of an outer panel of the flange is brought into contact with the bottom wall.

14. A weather strip according to claim 12, wherein the exterior side wall is formed of a solid rubber or sponge rubber.

15. A weather strip according to claims 12, wherein a cover lip is formed on an outer surface of the bottom wall so as to cover the bottom wall.

16. A weather strip according to claim 15, wherein a decorative layer is provided on an outer surface of the cover lip.

17. A weather strip according to claim 16, wherein the decorative layer is formed of any of a nonwoven fabric, woven fabric, fillings, colored thermoplastic elastomer or colored synthetic resin.
